(19) United States
(12) Patent Application Publication
(10) Pub. No.: US 2025/0101843 A1
(43) Pub. Date: Mar. 27, 2025

(54) HYDRAULIC FRACTURING BLENDER FOR OIL AND GAS WELLS

(71) Applicant: Ty-Crop Manufacturing Ltd., Rosedale (CA)

(72) Inventors: Gary Wayne TEICHROB, Rosedale British Columbia (CA); Ryan Joseph WILSON, Chilliwack British Columbia (CA); Matthew Raymond Silas EDWARD, Chilliwack British Columbia (CA); Brent Douglas VAN KLEECK, Chilliwack British Columbia (CA); Nathanael David SACCHETTI, Chilliwack British Columbia (CA); Mads BJØRNENAK, Kristiansand (NO); Erik Heimar ZACHARIASEN, Kristiansand (NO)

(73) Assignee: Ty-Crop Manufacturing Ltd., Rosedale (CA)

(21) Appl. No.: 18/892,650

(22) Filed: Sep. 23, 2024

Related U.S. Application Data
(60) Provisional application No. 63/539,868, filed on Sep. 22, 2023.

(51) Int. Cl. E21B 43/26; B01F 35/32; B01F 35/71; B01F 101/49; E21B 43/267

(52) U.S. Cl. CPC E21B 43/2607; B01F 35/3204; B01F 35/71725; B01F 35/7173; B01F 2101/49; E21B 43/267

(57) ABSTRACT

A blender tub for hydraulic fracturing operations and associated components are provided. A spinning proppant distributor located above the blender tub liquid level interrupts and redirects falling granular proppant material (e.g. sand) into the tub. A fluid intake channel wraps around at least part of the blender tub outside wall and introduces liquid (e.g. water) into the blender tub via a plurality of channels. The liquid is introduced with a force and angle which imparts a vortex within the blender tub. The above aspects facilitate blending of material within the tub.

### CROSS-REFERENCE TO RELATED APPLICATIONS

This application claims the benefit of priority of U.S. Application No. 63/539,868, filed Sep. 22, 2023, the contents of which are incorporated herein by reference.

### FIELD OF THE INVENTION

The present invention pertains to the field of oil and gas well production and stimulation, and in particular to hydraulic fracturing blender units for same.

### BACKGROUND

Hydraulic fracturing is a common technique for oil well production and stimulation. Typically, it requires large amounts of fluid (often water), proppant (often sand), and other dry or liquid chemical modifiers to be sent downhole at a high pressure. Once combined, the resulting slurry may be referred to as fracturing fluid. An important process in the practice of hydraulic fracturing is the mixing of the fluid, proppant, and chemical ingredients to produce a uniform fracturing fluid.

Thorough mixing of the ingredients is important for several reasons. First, unmixed proppant can form slugs, which are portions of the fracturing fluid with a high concentration of proppant. These slugs may damage pumps and process piping downstream, in addition to producing less desirable fracturing performance downhole. Second, chemical modifiers may have effects, such as reducing the friction of the fluid or helping suspend the proppant in the fluid. If not evenly and thoroughly mixed, these properties will not be present evenly throughout the fluid.

In addition to thorough and even mixing, there are many other considerations: avoiding unmixed or uncycled fluid due to dead spots in the flow, limiting the introduction of air, limiting dust, containing the mixture, preventing freezing, limiting energy use, maintaining the kinetic energy of the flow, and limiting maintenance.

Two methods of mixing are common in the industry: open tubs, and closed tubs. Open tubs are more common and resemble large mixing cauldrons where the ingredients are introduced. With open tub designs, ingredients are stirred in the center before exiting out a hole in the bottom. Closed tubs more closely resemble an open-top pump, where ingredients are mixed directly by an impeller, expeller, or some combination.

However, the various designs proposed and utilized thus far are subject to further optimization and improvement. For example, the distribution of proppant and the flow of fluid can be further improved to provide for improvements in at least one of the above-mentioned considerations. Therefore, there is a need for a hydraulic fracturing blending method and apparatus that obviates or mitigates one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present invention is to provide a hydraulic fracturing blender apparatus, such as a blender tub or apparatus including same. The tub may be characterized in various embodiments as an open blending tub with proppant distribution mechanisms. The tub may utilize a single wall and have a particular flow design. In various embodiments the blender apparatus may offer desirably good or improved flow and mixing properties. Another object is to provide components for a blender, such as a proppant distribution device.

Embodiments provide a system for effectively blending proppant, fluid, and chemical additives in the field of oil and gas extraction. The system potentially enhances mixing efficiency by considering factors such as, but not necessarily limited to, mixing energy, material distribution, air entrainment, mixing period, or a combination thereof. Various embodiments involve the use of a specialized single-wall blending tub with a particular layout that provides for high or even maximal available mixing volume both horizontally and vertically, as well as a proppant distribution device (also referred to as a proppant spinner).

According to embodiments of the present invention, there is provided an apparatus for distributing proppant into a blender tub of hydraulic fracturing equipment, the apparatus comprising: one or more surfaces configured to rotate about a vertical axis, the surfaces being located between a proppant source and a liquid reservoir of the blender tub, the surfaces configured (e.g. collectively configured) during rotation to interrupt proppant falling from the proppant source and to direct the proppant into the liquid reservoir (and liquid thereof, when present) with an altered trajectory.

In some embodiments, the surfaces include a plurality of radially extending partitions, a circumferentially extending outer wall, and a plurality of sector plates, the surfaces collectively defining a plurality of respective sectors and a plurality of apertures through which the proppant is directed into the liquid reservoir. At least one of the apertures may be adjustable. The partitions may be vertical or oriented at an angle of greater than 45 degrees.

In some embodiments, the surfaces include one or more plates for accumulating proppant, and one or more apertures in or proximate to the surfaces through which the proppant is directed into the liquid reservoir.

In some embodiments, the apparatus includes one or more protrusions or walls, which may be some or the aforementioned surfaces or other objects proximate to the surfaces, the protrusions or walls impeding, redirecting, or both impeding and redirecting flow of the proppant, e.g. within or from the other surfaces.

In some embodiments, the surfaces include at least one bottom surface extending generally horizontally and outwardly from the vertical axis, the at least one bottom surface defining, on its own or in cooperation with another one or more of the surfaces, one or more holes, apertures or gaps allowing downward passage of the proppant.

In some embodiments, the surfaces include one or more fins, walls or partitions extending upward from the at least one bottom surface and configured to impede or redirect flow of the proppant when supported on the at least one bottom surface.

In some embodiments, the one or more holes, apertures or gaps are oriented to allow the proppant to fall directly downward or to allow the proppant to flow horizontally off of an edge of the at least one bottom surface to then fall downward.

In some embodiments, the surfaces include two or more surfaces, the two or more surfaces defining at least one gap therebetween, the gap allowing horizontal or downward passage of the proppant.

In some embodiments, the at least one gap is adjustable by repositioning of the two or more surfaces relative to one another.

In some embodiments, the surfaces include two or more bottom surfaces extending generally horizontally and outwardly from the vertical axis, the two or more bottom surfaces defining at least one gap therebetween, the gap allowing downward passage of the proppant.

Also provided is a blender or blender tub of hydraulic fracturing equipment comprising the apparatus as described above.

According to other embodiments, there is provided a blender tub of hydraulic fracturing equipment comprising: a fluid intake channel disposed along an outer sidewall of the blender tub and extending helically or circumferentially around at least part of the outer sidewall; a plurality of fluid inlets formed in the outer sidewall and configured to provide fluid communication between the fluid intake channel and a main cavity of the blender tub; and a plurality of deflectors each associated with a respective one of the fluid inlets, each of the deflectors configured to direct fluid through the fluid inlets into the main cavity at an angle which contributes to imparting a vortex motion to fluid contents of the main cavity. The fluid intake channel may progressively narrow from an intake end to a terminal end thereof. The blender tub may further include the proppant distribution apparatus as described above.

In various embodiments, the fluid intake channel begins with an inlet end which is configured to receive fluid into the fluid intake channel. The fluid intake channel may be helical in shape, as mentioned above.

In some embodiments, at least one of the deflectors extends into the fluid intake channel.

In some embodiments, the at least one of the deflectors extends into the fluid intake channel in a direction that is angled toward an inlet end of the fluid intake channel.

In some embodiments, the at least one of the deflectors is curved along a single direction, and may be substantially flat in the direction perpendicular to that single direction. Alternatively, the deflectors may be curved in multiple directions.

In various embodiments, the plurality of fluid intakes are spaced apart at equal intervals along at least a portion of the fluid intake channel.

In some embodiments, the blender tub includes an open top in fluid communication with the main cavity and configured to receive proppant falling from a proppant source. Furthermore there is provided a proppant distribution device located between the open top and the proppant source, the proppant distribution device configured to interrupt proppant falling from the proppant source and to direct the proppant into the main cavity with an altered trajectory. The proppant distribution device may be stationary or moving, e.g. spinning or agitating, or a combination thereof.

Embodiments have been described above in conjunctions with aspects of the present invention upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1 shows a spinning proppant distribution device, according to embodiments of the present invention.

FIG. 2A shows a blender tub with the proppant distribution device of FIG. 1 and a fluid intake channel for imparting a vortex within the blender tub, according to embodiments of the present invention.

FIG. 2B shows an alternative view of FIG. 2A, with covers.

FIG. 3A shows another view of the blender tub of FIG. 2, according to embodiments of the present invention.

FIG. 3B shows an alternative view of FIG. 3A, with covers.

FIG. 3C shows a top sectional view of the blender tube and intake channel of FIGS. 3A and 3B.

FIG. 4 shows a cross sectional view of the blender tub of FIGS. 2A and 2B, according to embodiments of the present invention.

FIG. 5 shows another cross sectional slice of the blender tub of FIGS. 2A and 2B, according to embodiments of the present invention.

FIG. 6 shows a disc-shaped proppant distribution device, according to embodiments of the present invention.

FIG. 7A shows the proppant distribution device of FIG. 6 adjusted to fully close circumferential proppant flow gates, according to embodiments of the present invention.

FIG. 7B shows the proppant distribution device of FIG. 6 adjusted to partially close circumferential proppant flow gates, according to embodiments of the present invention.

FIG. 8 shows the proppant distribution device of FIG. 6 adjusted to fully open circumferential proppant flow gates, according to embodiments of the present invention.

FIG. 9 shows a proppant distribution device according to another embodiment of the present invention.

FIG. 10 shows a proppant distribution device according to yet another embodiment of the present invention.

FIG. 11 shows a proppant distribution device according to yet another embodiment of the present invention.

FIG. 12 illustrates a proppant distribution device according to yet another embodiment of the present invention.

It will be noted that throughout the appended drawings, like features are identified by like reference numerals.

### DETAILED DESCRIPTION

Unless defined otherwise, all technical and scientific terms used herein have the same meaning as commonly understood by one of ordinary skill in the art to which this invention belongs. The numbers and numbers combined with letters correspond to the component labels in all the figures.

Embodiments of the present invention provide for a hydraulic fracturing blender and associated methods, apparatus and system. Particular embodiments provide for a hydraulic fracturing blender tub or components thereof, such as a (e.g. spinning) proppant distribution device, vortex-inducing fluid intake channel, or both with a particular design as described herein. The combination of both a spinning proppant distribution device and a vortex-inducing fluid intake channel (e.g. rotating in the same direction or possibly counter-rotating) can facilitate material blending in the blender tub with various desirable aspects. For example, a reduction or elimination of moving parts within the blender tub fluid contents can reduce equipment wear and/or energy required for blending. The spinning proppant distribution device and vortex inducing fluid intake channel can also be useful individually.

Thorough blending of proppant and fluid, and possibly additional chemical additives, is influenced by several factors, including the following: how much mixing energy is imparted into the system, how evenly the materials are distributed prior to mixing, how much air is entrapped in the system, and how long the mixing period is.

The mixing period can be difficult to control, as typically materials are needed down-well as quickly as possible. However, tub volume affects available mixing time. In a blending system with no tub, the mixing period would be minimal, as ingredients would be sent through process piping with mixing occurring only within the piping. The opposite is true in a system with a large tub, where materials have more space and therefore more time to mix after being introduced, prior to being pumped out of the tub and into piping. Taller tubs may also reduce the chance of vortices forming that extend from the fluid surface to the discharge pump, which may cause cavitation. Therefore, a larger tub may be preferred in various applications. Embodiments of the present invention provide for a tub which may be designed to have a large capacity.

Embodiments of the present invention provide a single-wall blender tub, which provides for a large or maximal internal mixing area for a given a horizontal footprint. As well, a side discharge is provided, which allows for a taller tub overall, compared to the more common discharge location in the bottom center of mixing tubs. Therefore, the layout provides for large or even maximal available tub volume for a given horizontal and vertical footprint.

Another advantage of a larger tub is the reduced likeliness of overflowing or running dry when the discharge pump rate is not perfectly matched with the rate of materials entering the tub. Having a larger tub allows for a greater buffer to mitigate either of these conditions.

Entrapping air into the system is also a concern in a blender, as it can inhibit the proper mixing of materials, and potentially causes cavitation downstream. The most common mechanisms by which air is introduced into the system is via proppant falling into the fluid within the tub. When the proppant hits the surface of the fluid, the proppant can drag air with it, which then becomes mixed within the fluid and can be sucked into the discharge pump. The greater the force of the proppant hitting the surface, the more air is likely to be introduced. In most scenarios, the force is determined by the speed and the size of the group (or ‘clump’) of proppant that hits the fluid surface. As the proppant can fall from significant height and may be further propelled by a conveyor or auger or other system, the force can be significant. Damp proppant may clump into even greater sizes, compounding this issue further. Testing has also found that larger clumps are likely to contain more entrapped air.

In some embodiments of the invention, a method and apparatus to dissipate this force is provided. This may involve use of a passive proppant distribution device, such as a grid or bars placed above the tub, sized to allow particles to fall through without considerably disrupting the overall flow rate. The passive proppant distribution device may include bars or other surfaces extending in one or more directions, located between the proppant source and the blender tub, to define apertures allowing passage of the proppant. In some embodiments, a spinning proppant distribution device is used to further distribute these particles evenly while limiting or minimizing the force of the particles when striking the fluid surface, especially limiting or minimizing force in the vertical direction. Thus, a stationary or spinning proppant distribution device, also referred to as a proppant arresting device, is placed above the fluid in the tub, and interrupts the flow of proppant before it contacts the fluid. This interruption includes stopping or slowing the proppant, so that it enters the fluid at a lower speed, or otherwise with an altered trajectory (changed speed and/or direction). The use of a proppant distribution device may also effectively break up large clumps of proppant. The spinning proppant distribution device can spin continuously in one direction, or it can alternate directions. The spinning proppant distribution device can spin at a single fixed or configurable speed or it can change speeds over time. A proppant distribution device can move in other ways, for example by moving side to side at a predetermined frequency, or moving in multiple directions.

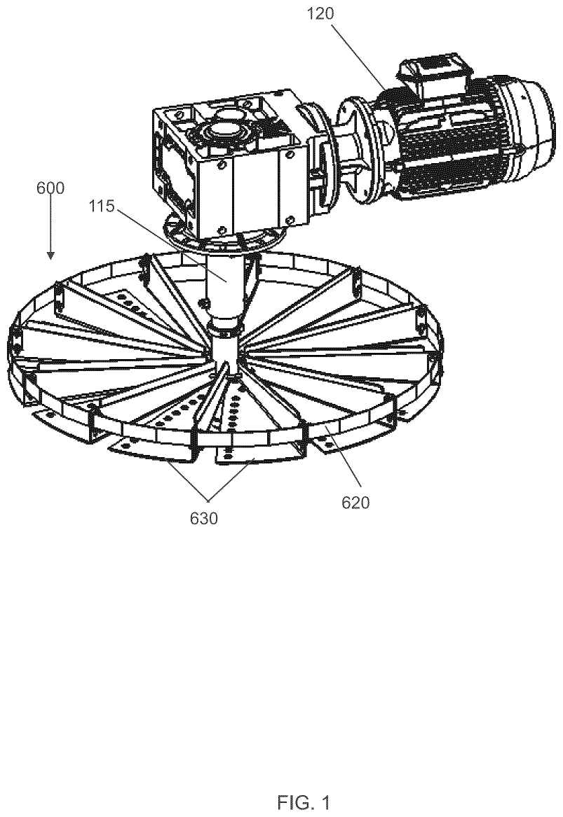

FIG. 1 illustrates an example spinning proppant distribution device 600 according to embodiments. from the device 600 is mounted to a rotatable shaft 115. A motor 120 is provided and configured to rotate the shaft 115. Proppant falls downward onto the device 600 while it is rotating, so that the device 600 redirects the proppant. The proppant thereby falls downward with a modified velocity and/or trajectory. The device 600 also arrests some downward motion of the proppant. Alternatively to the device 600, another device with rotating blades or other surfaces extending outward from the shaft 115 can be used.

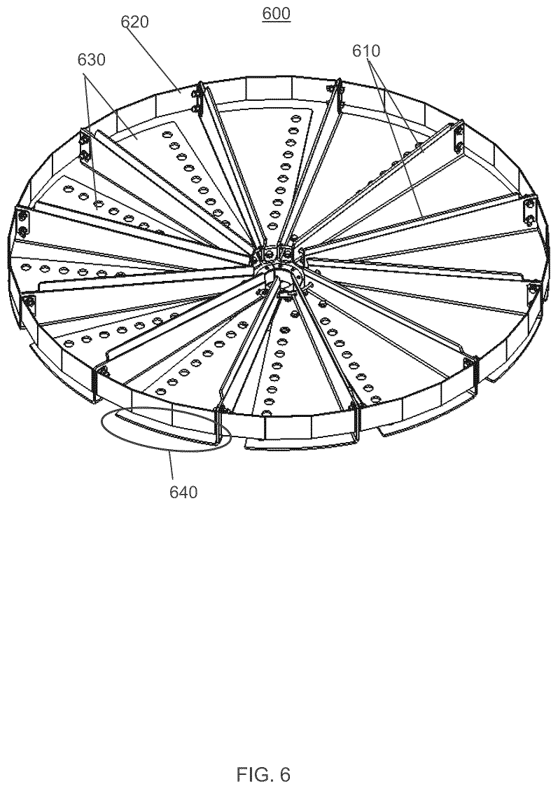

As shown in FIG. 1, as well as FIGS. 6 to 8, the device 600 may be configured so that a certain amount of proppant can be held (e.g. temporarily) on a horizontal surface, which includes sector plates 630 separated by gaps. The proppant will subsequently fall off of the device due for example to excess accumulation and/or motion of the proppant under centrifugal force to the outermost part of the device. An outer wall 620, or else end caps or fins may also be provided at the outermost edge of the blade to retain proppant (e.g. partially or temporarily). The size, orientation and shape of the device's surfaces will influence the speed, location and direction at which proppant will fall off of the blades.

In view of the above, the proppant distribution device includes one or more surfaces which rotate about a vertical axis, such as the axis of the shaft 115. The surfaces are above the blender tub's liquid level so that the device is between a proppant source and the blender tub's liquid.

In addition to dissipating force and thus limiting or minimizing the introduction of air into the system, these proppant distribution (arresting) devices may also more effectively distribute the materials over the fluid surface, allowing for more effective and even mixing of the ingredients. This is especially important as sand, the most common proppant, may be (for example) 12 times as dense as the fluid, causing it to fall towards the bottom discharge quickly; it has limited time to mix with the fluid. For example, a spinning proppant distribution device may catch proppant, thus reducing its speed, and then allow the proppant to fall from the proppant distribution device as it spins, thereby distributing it within the fluid.

A potential concern with such proppant distribution devices, is the creation of dust, which can be especially hazardous when using proppant containing high levels of silica. Excessive dust is undesirable or unacceptable when blending.

Testing has shown that specific proppant distribution device component shapes, angles, spacing, and speeds influence the effectiveness of such a proppant distribution device while limiting or minimizing the creation of dust. An effective design has been found to include or consist of a spinning disc with several circular sectors separated by partitions, as shown. In one embodiment of the invention, as shown for example in FIGS. 6 to 8, there may be 12 partitioned sectors. Within each sector, openings are provided along the bottom to allow some proppant to fall through, while the remainder is propelled to the outside edge of the sector by centrifugal force. More or fewer sectors may be provided for.

Testing also showed that slower rotational speeds of the proppant distribution device may be helpful to reduce dust. In one embodiment, a speed of 40 RPM was found to be ideal for minimizing dust while providing adequate distribution at any proppant flow rate. Accordingly, in some embodiments, the proppant distribution device may spin at about 40 RPM, or between about 30 RPM and about 50 RPM.

Another consideration is the limited vertical space in which a proppant distribution device may be required to reside. Due to the desire to maximize fluid volume, it may be desirable that as little room as possible should be occupied by such a device. Therefore, it may be desirable for the proppant distribution device to be vertically compact.

In more detail, FIGS. 6 to 8 illustrate a spinning proppant distribution device 600 which can be mounted to the shaft 115 and spun by the motor 120 as also shown in FIG. 1. The device 600 includes (in this case 12) vertically oriented, radially extending partitions 610, which extend toward and connect to a vertically oriented, circumferentially extending outer wall 620. The partitions 610 and the outer wall 620 collectively define (12) sector-shaped regions (sectors) into which proppant will fall. At the bottom of each sector-shaped region is a horizontally oriented sector plate 630, which may be affixed to and supported by one or more of the partitions 610, a central hub of the device 600, or both. In some embodiments, some or all of the radially extending partitions can extend from approximately the center to approximately the outer edge of the proppant distribution device. In some embodiments, some or all of the radially extending partitions can extend only along a portion of this full potential distance. Such partial partitions can include a single section or multiple spaced-apart sections, which may be aligned or staggered in the circumferential direction.

The sector plates 630 may be arranged to collectively form some or all of a horizontal spinning disc shape. The sector plates 630 may be spaced apart from one another to define sector-shaped apertures or gaps therebetween. The sector plates may include one or more holes therein. Each sector plates 630 may join or abut with a corresponding partition 610. Each sector plate, along with its adjacent partitions and section of outer wall, defines a sector of the proppant distribution device 600.

The outside edge of each sector may include or consist of an adjustable formed “gate.” A gate includes an aperture 640 of adjustable size. The aperture 640 can be adjusted by adjusting an angular position of a corresponding sector plate 630 either up or down, and then tightening the sector plate in place. The size of the aperture 640 can be adjusted to control the amount material (proppant) flowing out of the aperture as the device 600 spins. These gates can be adjusted to increase or maximize the even distribution of proppant per revolution, while reducing or minimizing carryover. In some embodiments, the speed of the spinning may be adjusted to perform the same task.

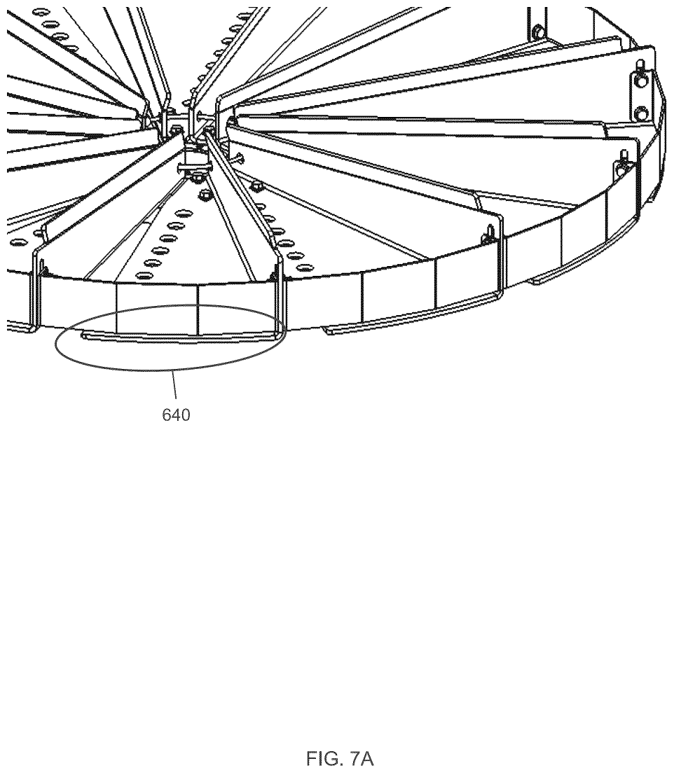

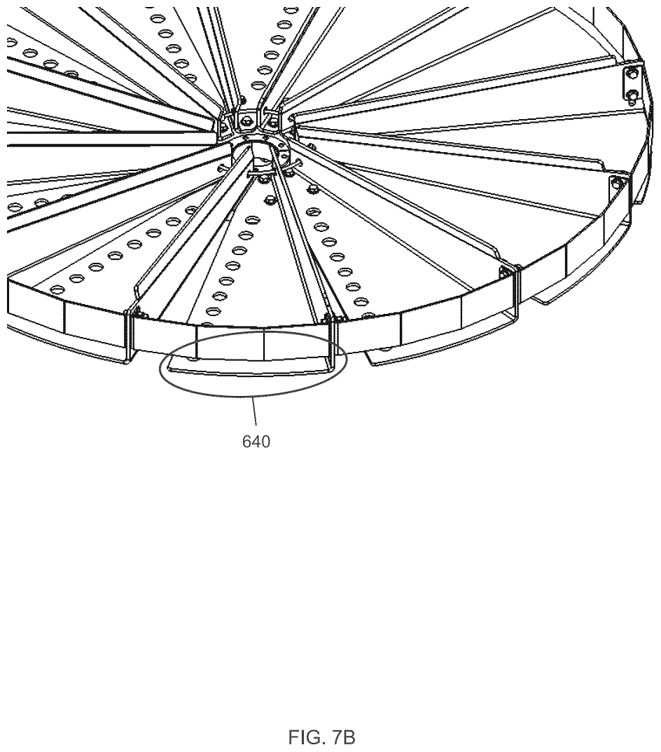

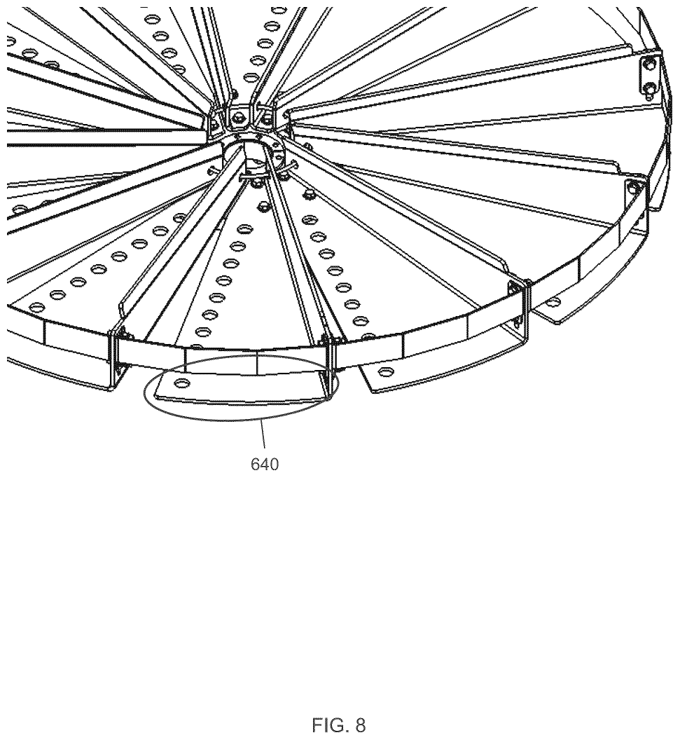

FIG. 7A illustrates the gates adjusted to a fully closed position so that the apertures 640 disappear. FIG. 7B illustrates the gates adjusted to an intermediate position so that the apertures 640 are between a minimum size and a maximum size. FIG. 8 illustrates the gates adjusted to a fully open position, so that the apertures 640 are substantially maximum in area. In some embodiments, the gates can be adjusted to a continuum of positions between fully closed and fully open. The gates can be adjusted (e.g. continuously) from a more closed position to a more open position by loosening a retaining mechanism such as one or multiple bolts, and then deflecting the bottom sector plate downward so that the space between the bottom sectoral body and the circumferential outer wall 620 is increased. This increased space allows for a higher rate of proppant discharge. The gates can similarly be adjusted in the reverse direction. The outer wall 620 inhibits or slows proppant from falling from the device 600 due to centrifugal forces. Depending on the size of the apertures 640, the amount or rate of inhibition can be adjusted. Apertures, holes or gaps can be any opening, horizontal or vertical, through which proppant can flow directly or indirectly toward the blender tub after being redirected by the proppant distribution device. Such apertures, holes or gaps can be part of a given plate or surface, or defined due to the separation between two such plates or surfaces.

The bottom sector plates 630 can be adjusted to allow a higher or lower rate of proppant discharge in other ways. For example, additional or fewer holes can be provided in the partitions, or the partitions can be swapped or re-sized to adjust the sizes of the sector-shaped apertures or gaps between successive sector plates. Holes can be selectively closed or plugged in some embodiments. During spinning, proppant will tend to accumulate first at one side of the partition (e.g. when the proppant distribution device spins clockwise, proppant will accumulate first at the location of the partitions away from the holes and gaps, that is at the intersection of a sector plate 630 and a partition 610 in contact with that sector plate. However, if the gates are sufficiently closed, proppant will continue to accumulate until it reaches and falls through the holes, sector-shaped gaps, or both. By adjusting the partition shapes, holes, and gates, as well as the rate of spin and the rate at which proppant (and other chemicals) is introduced, the rate of introduction of proppant, the volume and position of proppant introduction, as well as its velocity at introduction, can be adjusted.

The partitions may be further configured to mitigate or minimize proppant deflection and turbulence as the proppant falls. This may be accomplished by bending each sector plate 630 (also referred to as a partition fin). For example, a trailing edge or an outer edge of a sector plate can be bent upward or downward to influence the trajectory of proppant exiting same. The sector plates can be oriented as needed to optimize the trajectory of the proppant into the tub, in order to mitigate turbulence for example.

As illustrated, the partitions 610 are generally vertically oriented. However, in other embodiments, the partitions 610 can be oriented at an angle between 45 degrees and vertical. The partitions 610 can be pitched toward or away from the direction of rotation at such an angle (e.g. greater than about 45 degrees). The sector plates 630 can be approximately horizontal, or pitched downward or upward from horizontal by a few degrees. The partitions, the sector plates, or a combination thereof, can be flat or curved. The shape, as well as the shape and inclusion of end caps or outer wall 620 provide for a certain overall profile of spinning surfaces which interrupt the falling proppant and direct the proppant into the blender tub liquid with a certain altered trajectory. The profile can be configured to impart a desired such trajectory, including direction, velocity, dispersion, etc. of the proppant into the blender tub liquid, as a function of incoming direction, velocity, dispersion, etc.

The spinning proppant distribution device 600 is designed to be located and operated primarily outside of the fluid, though a central shaft 115 may extend below the spinning portion into the fluid (not shown). In various embodiments, no bearings or support for the apparatus is necessarily required within the fluid; it is fully supported and powered from above. If beneficial to mixing, paddles or blades or similar protrusions can be affixed to the central shaft 115 and configured to rotate within the fluid.

In some embodiments, the proppant distribution device's vertical distance above the fluid can be adjustable and can be adjusted depending for example on fluid level.

In some embodiments, the components of the proppant distribution device may be constructed from formed metal and assembled or welded together.

Imparting kinetic energy into the blender tub system is one simple method of mixing. Traditionally, this was done using a mixing apparatus located below the normal fluid level in the tub, and powerful hydraulic or electric motors would be used to spin the apparatus. The mixing apparatus may be made up of paddles, blades, propellers, or similar shapes to agitate the slurry to facilitate mixing. However, this requires significant power, and the device tends to wear out quickly; the abrasive slurry wears down components quickly, including the mixing apparatus itself and the bearings to support it. The proppant distribution device as described herein may be used in place of or in addition to such a mixing apparatus to mitigate or eliminate the need for same. The proppant distribution device imparts kinetic energy to the proppant prior to (e.g. just or immediately prior to) mixing the proppant into the fluid, thus facilitating mixing.

A spinning proppant distribution device (proppant spinner) may thus be provided, and may be helpful in breaking up clumps of proppant, including if such proppant is wet or damp. Dry chemical additives are commonly added to the blender tub as well. A spinning proppant distribution device may help distribute the dry chemical across the surface of the fluid. The proppant distribution device may also be configured to receive and spin the dry chemical additives for this purpose.

In some embodiments, the proppant distribution device is spun in the same direction as a motion of the fluid, allowing the motion of the proppant to follow a similar vector as the fluid as it enters the fluid.

In some embodiments, the tops of the partitions 610 of the proppant distribution device are (e.g. slightly) bent to add additional strength to the partitions and overall device.

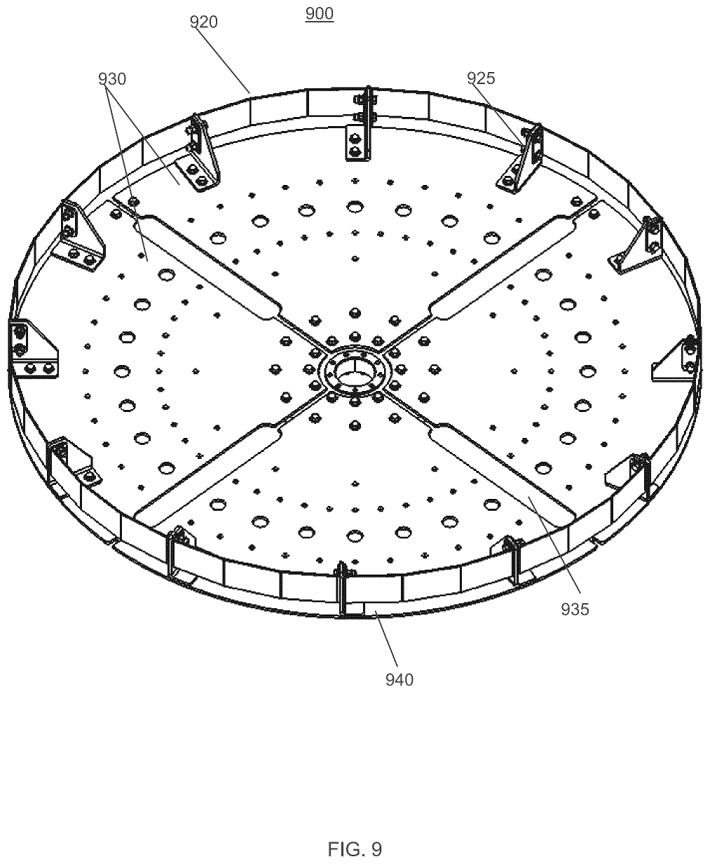

FIGS. 9 to 11 illustrate alternatives to the proppant distribution device 600 of FIG. 6, according to embodiments. Referring to FIG. 9, the spinning proppant distribution device 900 includes a circumferential outer wall 920 and (in this case four) sector plates 930. Fully radially extending partitions are omitted, but one or more such partitions, or other upward protrusions from the sector plates (inward from the outer wall) may be included in some embodiments. The brackets 925 connecting the outer wall 920 to the sector plates 930 might act (at least partially) as such protrusions. Such partitions, protrusions, walls or brackets may act to impart rotational force to material held on the sector plates, to hold the material radially inward to slow its progress toward the outer edge of the proppant distribution device 600, or a combination thereof, depending on their orientation. Between the sector plates are variable-width gaps 935 through which some material may fall. Holes (e.g. of varying sizes) are also provided in the sector plates and material may fall through such holes. A gap 940 between the outer wall 920 and the sector plates 930 is also shown. Proppant moving toward the outer edge of the sector plates 930 may be distributed through the gap 940. The gap may be adjustable in size by adjusting the brackets 925.

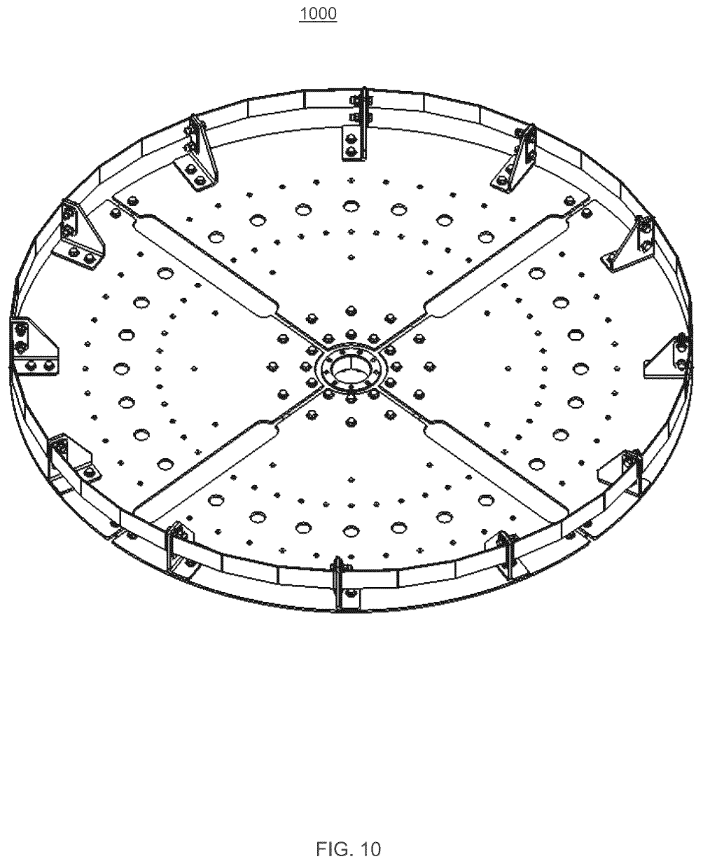

FIG. 10 illustrates a spinning proppant distribution device 1000 similar to the device 900 of FIG. 9, except that the height of the outer wall is smaller, the gap between the outer wall and the sector plates is larger, or both.

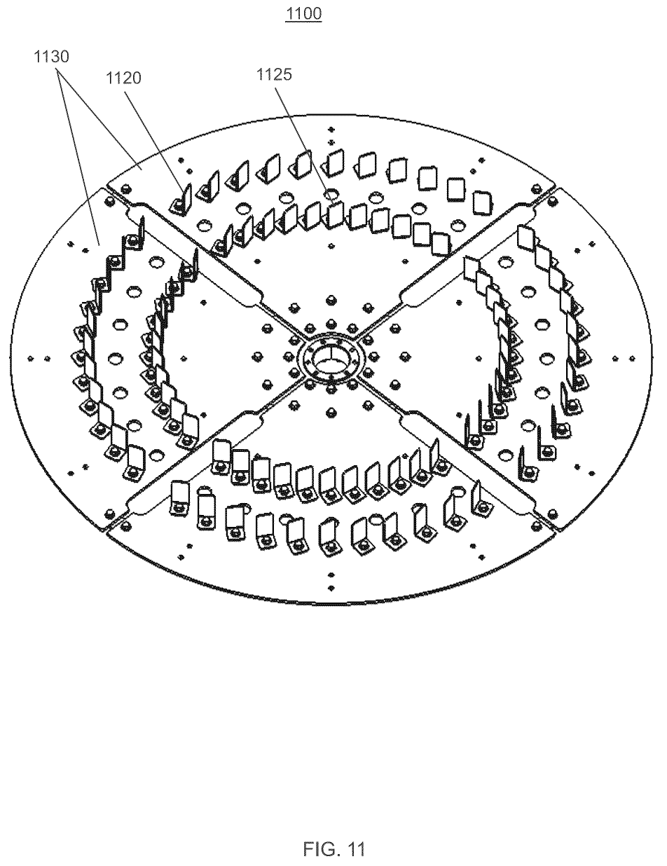

FIG. 11 illustrates a spinning proppant distribution device 1100 according to another embodiment. In this case, the outer wall is omitted but the device is otherwise similar to the device 900. Instead of (or in addition to) an outer wall, the device 1100 includes two concentric rings 1120, 1125 of upward protrusions, which are also referred to as fins. The rings are radially inward from the outer edge of the sector plates 1130 and are mounted to the sector plates. There are gaps between the protrusions allowing proppant to flow radially outward under centrifugal force. The protrusions thus impede but do not completely stop the outward flow of proppant, thus controlling the rate at which proppant is distributed by falling off of the outer edge of the plates 1130. In other words, the proppant flow is redirected by the protrusions. Protrusions, which may be brackets, walls, partitions, or the like, in other embodiments as illustrated herein can similarly impede and/or redirect proppant flows. Such impeding or redirecting can generally be due to the rotating motion of the proppant distribution device, and the resulting generally horizontal and circular motion of the protrusions. More or fewer rings can be provided. Rather than rings, the protrusions can be arranged in another manner, such as but not necessarily limited to a spiral shape. The protrusions can be with one another aligned or staggered. The protrusions are oriented so that their faces are substantially perpendicular to the radial direction of the device 1100, however the faces may be oriented at a different angle, for example partway between parallel and perpendicular to the radial direction. Different protrusions can have different orientations.

More generally, and in view of the above, the proppant distribution device can include one or more surfaces which interrupt and redirect proppant flow during and due at least in part to their rotation. The surfaces can include at least one bottom surface, such as a sector plate, which extends generally horizontally and outwardly from a vertical axis, which is the axis of rotation of the proppant distribution device. The bottom surface can be horizontal, i.e. extending perpendicularly to the axis of rotation. The bottom surface can be flat, curved, or angled.

The surfaces define one or more holes, apertures or gaps that allow proppant to flow toward the blender tub liquid. The holes may be holes within bottom surfaces. The apertures or gaps may be between bottom surfaces, for example between sector plates, allowing proppant to flow off the edge of a bottom surface and then subsequently downward. The apertures or gaps may be between bottom surfaces and other surfaces, for example between a sector plate and a circumferential wall, again, allowing proppant to flow off the outer edge of a bottom surface and then subsequently downward. Accordingly, and depending on their location and orientation, the holes, apertures or gaps allow the proppant to fall directly downward or allow the proppant to flow horizontally off of an edge of the at least one bottom surface to then fall downward.

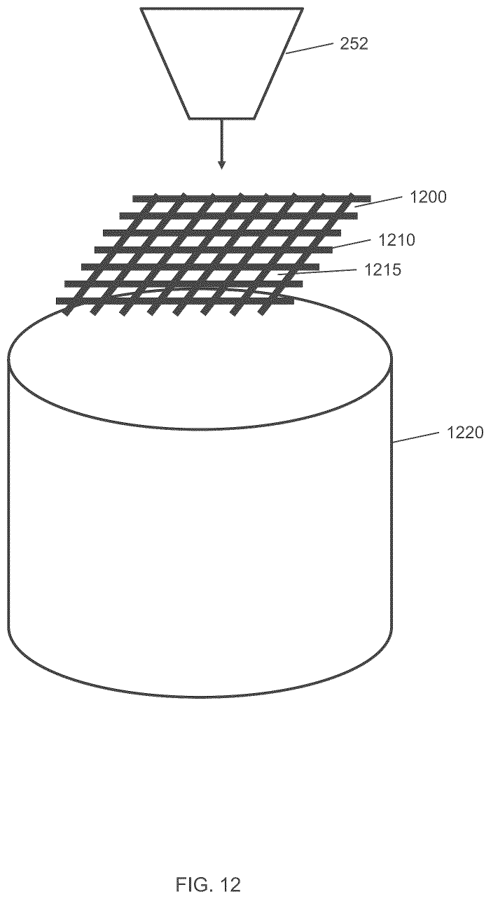

FIG. 12 illustrates a proppant distribution device 1200 according to yet another embodiment of the present invention. In this embodiment the proppant distribution device is passive, e.g. stationary rather than spinning. The device is located between the source 252 of proppant and the blender tub 1220, and includes solid portions 1210 which are located within the path of falling proppant, in order to contact and redirect the proppant. This distributes the proppant into the blender tub by altering its trajectory. The solid portions also define apertures 1215 through which the proppant falls, e.g. after being redirected.

When fluid is pumped into the blender tub, it is done so by a suction pump that adds significant speed and thus energy to the flowing fluid. The tub as described herein may be designed to preserve the energy already carried by the fluid as it enters the tub, which is normally dissipated by double-walled tubs or tubs of other designs. This may involve using a channel (for introducing water or other fluid into the tub) having a “ram horn” shape, which progressively narrows as it encircles the tub. The water inlets may include angled sections within the “ram horn” that allow water to enter the tub and continue in a spiraling or otherwise angled direction. That is, the water enters the blender tub through the blender tub's sidewalls. The water is directed, via deflectors, inward at an angle other than directly radially inward toward a center of the tub. That is, the direction is angularly between the radial inward direction and the direction which is tangential to the tub sidewall. The result is a high-energy, spinning area (vortex) near the bottom of the tub, without requiring any additional powered paddled or blades to cause such a vortex. The removal of powered paddles/blades is a cost saving measure, as it lowers the capital cost of the equipment as well as the operating cost as it is a high-wear item.

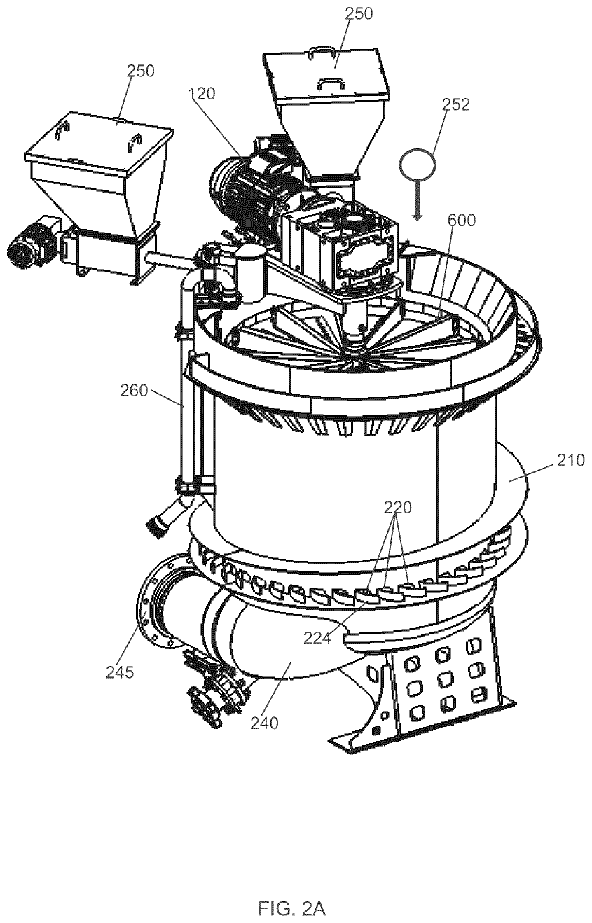

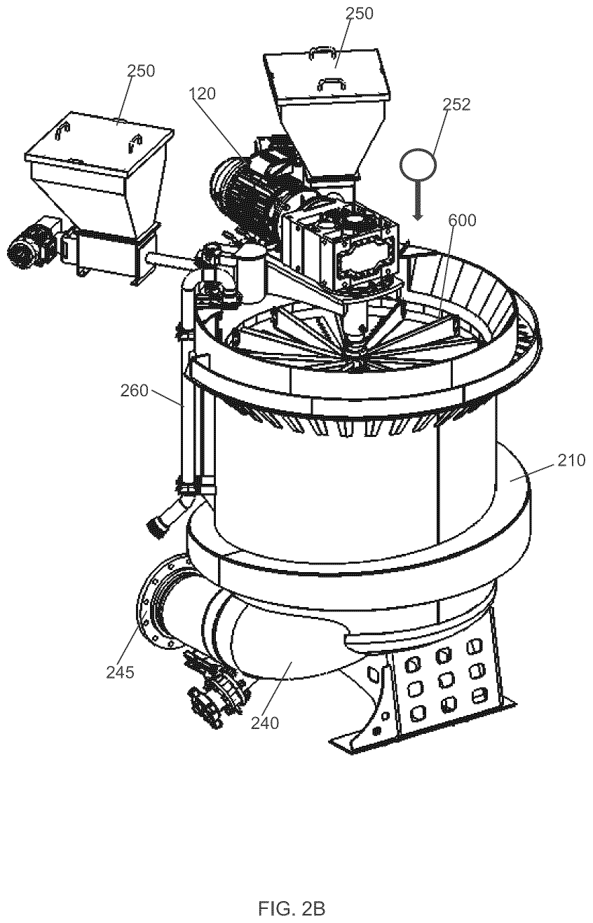

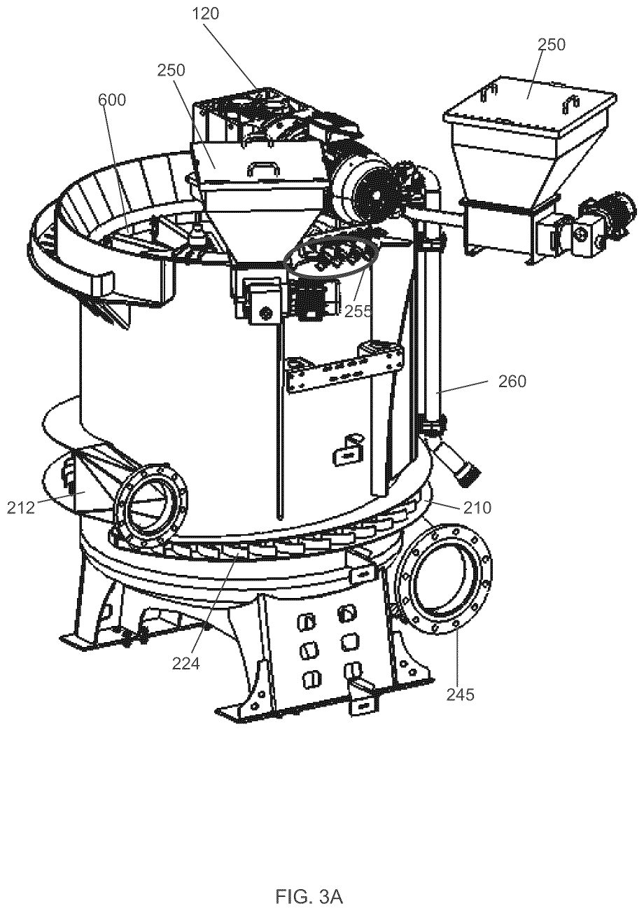

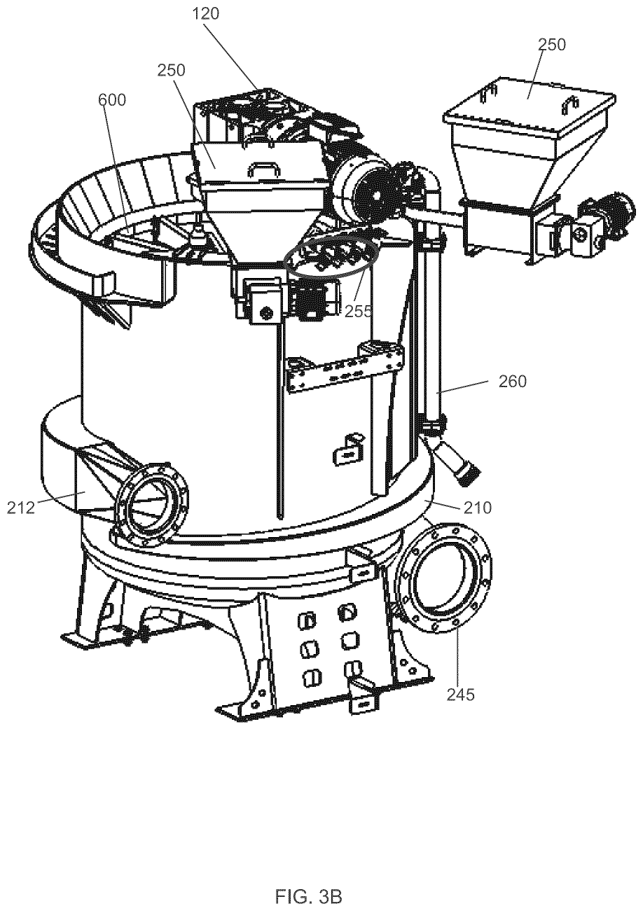

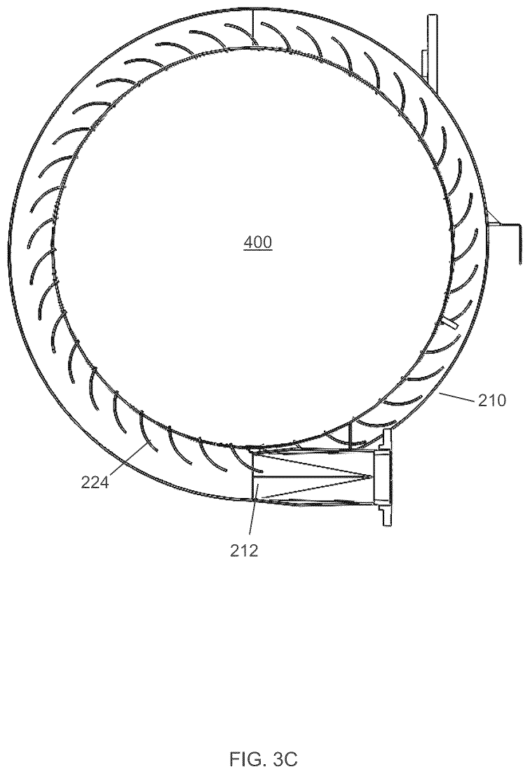

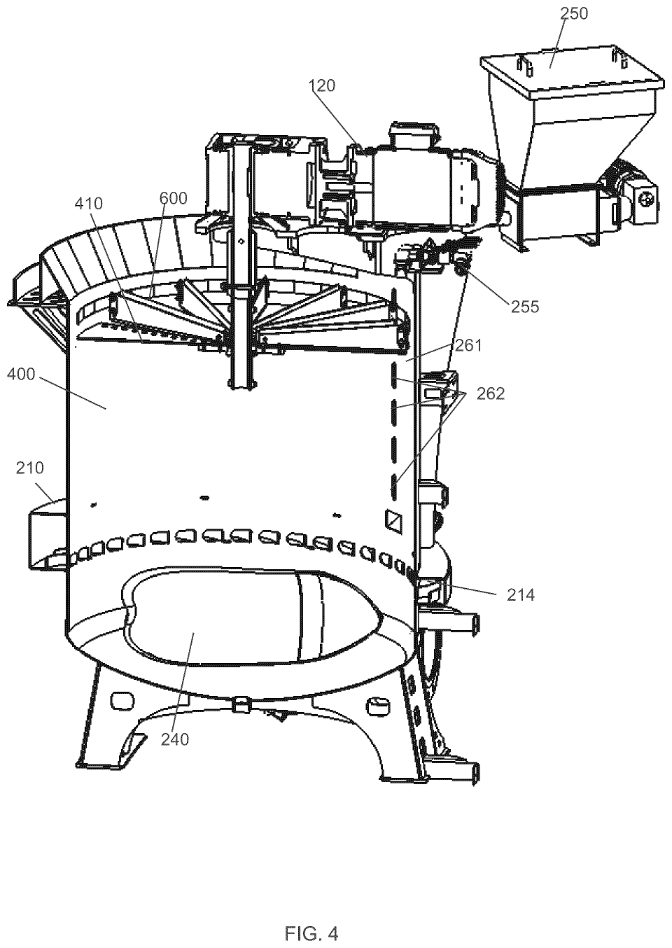

Referring by way of example to FIGS. 2A to 4, the ram horn shape refers to a fluid intake channel 210 which follows a helical (or otherwise curved, circular or semicircular) path and which encircles the main area of the blender tub. This (e.g. helical) fluid intake channel 210 progressively narrows from a first inlet end 212 (FIGS. 3A to 3C) which receives water toward a second terminal end 214 (FIG. 4). The progressive narrowing may be at a substantially constant rate along the length of the channel, e.g. a constant decrease in cross-sectional area per unit of distance travelled down the channel from the first inlet end toward the second terminal end. The channel 200 is fluidically coupled with the blender tub at multiple different locations (the water inlets, also referred to as fluid inlets, referring to a liquid fluid) along the length of the fluid intake channel 210, and along a circumference of the tub. The water inlets 220 each provide for a smaller channel oriented at an angle so that water is introduced into the blender tub at an angle, to impart a spinning motion to the water in the blender tub. In one embodiment, the inlet deflectors are angled at about 67 to 68 degrees relative to a tangent line to the tub sidewall. This is the angle between tangent line and deflector, measured on the upstream side of the deflector. In some embodiments, the water inlets may each have a cross section of approximately 6.32 square inches, and there may be about 39 such inlets. Each water inlet includes an aperture providing fluid communication between the channel and the blender tub, and a deflector 224 which guides (directs) water from the channel to the aperture so that the water exits the aperture into the blender tub at an angle. The deflector 224 may be curved. The deflector may be coupled to the inner sidewall of the channel at a location which is generally at a downstream edge of the associated aperture. The deflectors can also be angled to purposely create a turbulent area, or areas, instead of a single vortex as varying intensity and direction of flow may improve mixing performance. As illustrated, a deflector extends into the fluid intake channel, and may be formed of a generally curved body. Also as shown the deflector extends upstream into the fluid intake channel, that is, toward an inlet end of the fluid intake channel. As also illustrated, the deflector may be curved along a single direction, i.e. curved along its length of extension into the fluid intake channel, (i.e. perpendicular to its base where the deflector attaches to the blender tub/fluid intake channel), but flat in the direction perpendicular to this length of extension into the fluid intake channel.

In some embodiments, the inlet end 212 is about 84 square inches in area, e.g. a 7 inch by 12 inch rectangular opening. In some embodiments, the terminal end 214 is about 7.4 square inches in area, e.g. a 2 inch by 3.7 inch rectangle. The channel 210 may have a length of about 188.4 inches. This channel may encircle a blender tub of 60 inch diameter approximately one time, i.e. 360 degrees.

In one example embodiment, the blender tub and channel 210 are configured to handle a flow of up to 150 barrels per minute (397 litres per second) of slurry outlet at a typical pressure of about 110 psi. The water inlet flow may be about 130 barrels per minute (344 litres per second) with a water pressure between 0 and 100 psi, typically around 40 psi.

The water inlets are formed at least partially in an outer sidewall of the blender tub, to provide fluid communication between the fluid intake channel and a main fluid holding part (cavity) of the blender tub. The fluid intake channel is disposed along such an outer sidewall, wrapping around the blender tub.

The water inlets are arranged spatially so that different water inlets occur at different distances, measured along the channel, from the channel's inlet. Typically the last such water inlet would be at or proximate to the terminal end 214 of the fluid intake channel.

It is noted that the vortex, being driven by water (or other fluid) introduced into the main cavity (also referred to as the liquid reservoir) of the blender tub (via the water inlets and by virtue of the deflectors), would cease (due to friction) shortly after such water stopped being introduced, absent other driving means. However, for blender operations fluid is frequently or continuously extracted from the blender tub and frequently or continuously topped up via the fluid intake channel 210. Thus, it is considered that the vortex is present either continuously or for a sufficient proportion of time to facilitate adequate blending or mixing of the liquid proppant mixture.

The spinning fluid is then readily or easily pulled into the inlet of a discharge pump via an outlet, located on a side of the tub at the bottom, which pumps the mixed slurry into additional process piping on the blender before exiting via a discharge manifold. Accordingly, the blender tub may be fluidically coupled to an outlet at a bottom of the blender tub, e.g. with the fluidic coupling taking place at a side edge of the blender tub. The outlet is used to provide the blended fluid to further components of the operation.

FIGS. 2A to 4 illustrate the fluid outlet channel 240 and connector 245, in one embodiment. Such features are also shown in FIGS. 3A to 4. The connector 245 may be coupled to a discharge pump (not shown), and this may be the main route by which blended liquid is dispensed.

FIGS. 2A to 4 further illustrates a pair of hoppers 250 which are configured to dispense proppant materials (e.g. dry granular chemical additives) downward toward the proppant distribution device. In some embodiments, the bulk of the proppant material (e.g. sand) may be delivered via a conveyor belt or auger (not shown) and dispensed from the conveyor belt or auger downward into the blender tub e.g. directly or via a hopper, funnel or other device. The proppant material, dispensed in this manner, will contact the proppant distribution device. Proppant may fall downward from a source location 252 such as illustrated in FIGS. 2A and 2B.

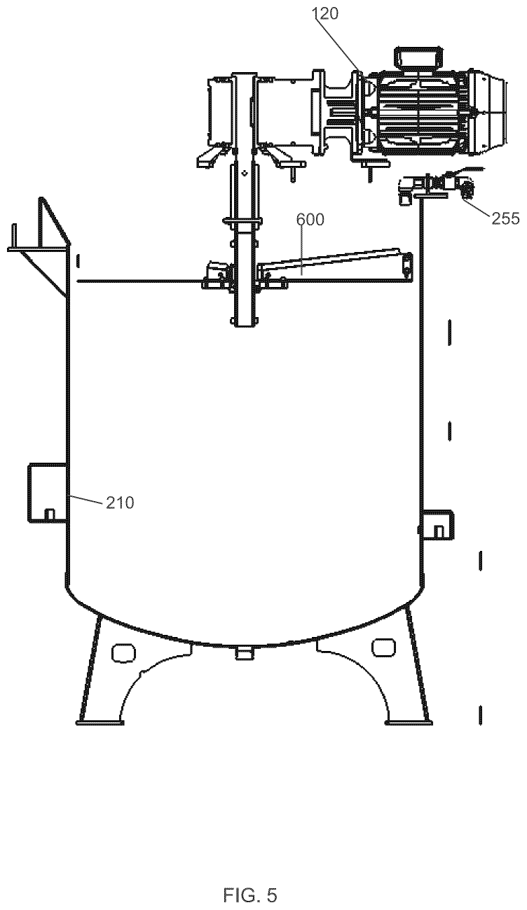

FIGS. 3A to 5 further illustrate fluid channels 255 which may be used for a variety of purposes such as introducing liquid chemical additives into the blender tub.

FIGS. 2A to 4 further illustrate a fluid channel 260 which may be used for a variety of purposes such as cleanout, or introducing clean water or liquid chemicals into the blender tub or drawing liquid out of the blender tub.

Also shown is a channel 261 or tube which is in fluidic communication with the blender tub interior via a plurality of apertures 262 at different heights. This channel 261 may house a fluid level sensor.

In more detail, FIGS. 2A to 4 illustrate the blender tub including a main cavity 400, also referred to as a liquid reservoir. Proppant falls into the blender tub main cavity via an open top 410 which is exposed to the source of proppant, with the proppant distribution device 600 (when present) located between the source of proppant 252 and the open top 410. The open top 410 is thus open in the sense that it provides fluid communication with the proppant source 252. The region surrounding the proppant source, proppant distribution device and open top may otherwise be enclosed or shrouded. Additives from hoppers 250 may similarly be received through the open top after passing through the proppant distribution device.

In some embodiments, the blender tub may be insulated to allow for operations in colder temperatures.

In some embodiments, heat exchangers may be attached to the outside of the blender tub, allowing for both the cooling of heat-generating devices onboard the blender, and increasing the temperature of the tub for operations in below-freezing locations.

In some embodiments, an attachment bracket encircles a portion of the blender tub near the top, allowing for conveyors, augers, or other proppant-delivery devices to be attached to the tub. The length of this bracket allows for the device to be positioned securely at a variety of angles.

In some embodiments, multiple level sensors may be used to determine the actual fluid level of the tub. These may include mechanical floats, radar sensors, or other sensors. In some embodiments, these sensors may be placed within a tube or channel (e.g. 261) external to the blender tub's wall, but with openings to allow the fluid level in the tube to match the level within the tub. In some embodiments, the radar or other sensor will be positioned under the proppant spinning apparatus to prevent false echoes from the proppant distribution device. In some embodiments, the radar or other sensor may rely on software to filter out such echoes or other signal noise from proppant and the proppant spinning apparatus.

In some embodiments, one, two or more radar, laser, microwave, optical, acoustic, or other distance-based sensor is placed above the proppant distribution device, directed downward toward the blender tub and configured to monitor fluid level in the blender tub. Multiple such sensors may be used to obtain a more accurate measurement, particularly in view of signal interference (noise) introduced by motion of the proppant distribution device and, possibly, the proppant itself. Such sensors may be synchronized with motion of the proppant distribution device, so that they only take readings when a gap in the proppant distribution device is in line between the sensor and the blender tub fluid. Alternatively, the sensors may take readings continuously, and incorrect readings due to reflections off of the proppant distribution device surfaces can be filtered out subsequently. In some embodiments, this filtering utilizes information indicating operation of the proppant distribution device, such as its position (obtained from rotary encoders), velocity, or the like. In some embodiments, the sensor readings do not necessarily utilize such information, but rather provide information regarding the position and/or velocity of the proppant distribution device. For example, periodic interference in the radar signals may be used to infer velocity of the spinning proppant distribution device.

In some embodiments, additional dust suppression can be achieved using a cover. This cover may be flexible, using a material such as synthetic-fiber fabric. In some embodiments, the covered area can be maintained with a constant negative pressure, with removed air either filtered, or expelled in an area away from personnel.

In some embodiments, a spray of water or similar fluid may be used to reduce dust. This spray may form a dome that appears to contain the top of the tub, preventing most of the dust from escaping. In some embodiments, the spray consists of several nozzles spaced around the top of the tub, spraying together to form a dome or wall of mist or spray.

In some embodiments, a laser may be provided and configured to measure the volume of the proppant entering the blender tub. This can be combined with the measured weight of the proppant to determine proppant density dynamically.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. A blender tub of hydraulic fracturing equipment comprising:
a fluid intake channel disposed along an outer sidewall of the blender tub and extending helically or circumferentially around at least part of the outer sidewall;
a plurality of fluid inlets formed in the outer sidewall and configured to provide fluid communication between the fluid intake channel and a main cavity of the blender tub; and
a plurality of deflectors each associated with a respective one of the fluid inlets, each of the deflectors configured to direct fluid through said respective one of the fluid inlets into the main cavity at an angle which contributes to imparting a vortex motion to fluid contents of the main cavity.

2. The blender tub of claim 1, wherein the fluid intake channel begins with an inlet end which is configured to receive fluid into the fluid intake channel.

3. The blender tub of claim 2, wherein the fluid intake channel progressively narrows from the inlet end to a terminal end thereof.

4. The blender tub of claim 1, wherein the fluid intake channel is helical in shape.

5. The blender tub of claim 1, wherein at least one of the deflectors extends into the fluid intake channel.

6. The blender tub of claim 1, wherein the at least one of the deflectors extends into the fluid intake channel in a direction that is angled toward an inlet end of the fluid intake channel.

7. The blender tub of claim 1, wherein the at least one of the deflectors is curved along a single direction.

8. The blender tub of claim 1, wherein the plurality of fluid intakes are spaced apart at equal intervals along at least a portion of the fluid intake channel.

9. A system including:
the blender tub of claim 1, the blender tub further comprising an open top in fluid communication with the main cavity and configured to receive proppant falling from a proppant source; and
a proppant distribution device located between the open top and the proppant source, the proppant distribution device configured to interrupt proppant falling from the proppant source and to direct the proppant into the main cavity with an altered trajectory.

10. The system of claim 9, wherein the proppant distribution device is stationary.

11. The system of claim 9, wherein the proppant distribution device is moving.
